(19) United States
(12) Patent Application Publication
(10) Pub. No.: US 2007/0075621 A1
(43) Pub. Date: Apr. 5, 2007

(54) Discharge lamp having inner electrode pairs

(76) Inventor: Hans-Gerhard Burzele, Herbrechtingen (DE)

Correspondence Address: OSRAM SYLVANIA INC, 100 ENDICOTT STREET, DANVERS, MA, 01923, US

(21) Appl. No.: 11/527,683

(22) Filed: Sep. 27, 2006

(30) Foreign Application Priority Data
Sep. 30, 2005 (DE) 10 2005 047 079.3

(51) Int. Cl. H01J 63/04; H01J 1/62

(52) U.S. Cl. 313/492; 313/491; 313/484

(57) ABSTRACT

The invention relates to a discharge lamp having dielectrically coated electrodes, in which the electrodes 4-7 as a pair have a path form with curves, in which the electrodes 4-7 remain essentially uniformly spaced apart.

### TECHNICAL FIELD

The invention relates to a discharge lamp having at least partially dielectrically coated inner electrodes.

### BACKGROUND ART

Discharge lamps having dielectrically coated electrodes are designed for so-called dielectrically impeded discharges, in which only a displacement current can flow owing to the dielectric coating and which are therefore operated in the radiofrequency range. Discharge lamps of this type are known per se, in particular also as Hg-free discharge lamps, which are provided for producing noble gas excimers, in particular Xe excimers.

In addition, such discharge lamps having electrodes in the form of elongate paths are known, i.e. electrode forms which have a considerable length in relation to their width and even more so their thickness. Such electrode paths are also known as pairs having different polarity during operation—during DC operation or else during AC operation—which maintain an essentially constant gap in relation to one another. During operation, discharges between the two electrodes of a pair burn over this discharge gap, it being possible for the discharges to be split into individual discharge structures or else to be in the form of more or less cohesive total discharges depending on the specific design of the electrode form and in accordance with the operating conditions. Such electrode pairs having an essentially constant discharge gap are known in particular as straight, elongate electrode strip pairs on the walls of flat, planar discharge vessels and also of thin, rod-shaped discharge lamps. In the case of such electrode pairs, small projections may be formed moreover on one or both of the electrodes, which projections are used for localizing individual discharge structures by means of electrically induced preferred positions, but only change the discharge gap slightly.

### DISCLOSURE OF THE INVENTION

The present invention is based on the technical problem of specifying a discharge lamp having at least one pair of electrodes in the form of elongate paths, which discharge lamp provides design advantages.

The invention relates to a discharge lamp having a discharge vessel and at least two electrodes in the discharge vessel, which are in the form of elongate paths and are formed as a pair of electrodes which are spaced essentially uniformly apart by the discharge gap, and of which at least one is dielectrically coated, wherein the electrode pair has a path form having a plurality of path curves, the electrodes of the electrode pair being spaced essentially uniformly apart in the path curves.

In addition, the invention relates to an illumination system comprising such a discharge lamp and an electronic ballast which is suitable therefor.

Preferred refinements will be explained in more detail below.

The essential features of the invention consist in the fact that the electrodes of the at least one electrode pair are situated within the discharge vessel and in the process describe a plurality of curves in the discharge vessel despite their essentially uniform discharge gap. This electrode structure has the advantage over electrodes running in a straight line along the discharge vessel that the total electrode length is independent of the dimensions of the discharge vessel, in particular may be longer. The arrangement within the discharge vessel in turn has the advantage over outer electrodes that it is not the discharge vessel walls which predetermine a specific minimum thickness for the thickness of the dielectric layer (and the discharge gap), which may be disadvantageous both in terms of the efficiency and also in terms of the voltage to be reached and therefore the design of the ballast. Instead, electrode gaps and lengths which are determined exclusively by the desired electrical parameters can be selected independently of the discharge vessel geometry. It is also possible for different electrode geometries to be used for one and the same discharge vessel form and wall thickness in order to vary the electrical parameters. In particular, the electrode length can be adjusted particularly easily such that, given a predetermined lamp power, the desired current density in the discharges can be achieved and it is not necessary for an unfavorably high current density to be selected, for example owing to a total length which is too short.

It is essential here that the electrodes implement the described path curves to a certain extent jointly and “synchronously” with one another, i.e. phase differences, for example, are not predetermined on the basis of which the path curves result in corresponding modulation of the discharge gap. The small projections for determining the location of individual discharges which have already been mentioned at the outset and are known from the prior art are naturally also possible within the context of this invention, for which reason the discharge gap should only be “essentially” uniform. However, this also means that the curve form per se should not exert any relevant influence on the discharge gap. Moreover, the electrode gap can naturally be different outside the curves and the discharge region, i.e. for example in the region of the power supply to the electrical contacts.

The mentioned curves preferably adjoin one another, i.e. are not separated by essentially straight lengths of electrodes. In addition, the electrode paths are virtually completely formed from path curves in the discharge region, i.e. in the part of their length in which discharges are intended to occur. In this form, particularly long electrode lengths can be accommodated in limited lengths of a discharge vessel.

In addition, the electrode forms are preferably unbranched, i.e. continuous. In this case, the path curves should also be such that, to a certain extent, when passing through a curve it is always in the same direction along the electrodes and it is not necessary to go back and forth at one of the two electrodes on the same section.

One preferred refinement envisages two-dimensional curves, i.e. electrode paths which lie essentially in one plane. Particularly preferred are meandering electrode paths, for example sinuous designs or designs having another wave shape.

In another preferred refinement, the electrodes are three-dimensional and the curves are arranged spatially. In this case, wound forms, in particular helical forms, are particularly preferred. However, in this case, the term “wound form ” should also encompass those forms having a variable pitch or variable radius.

Both in the two-dimensional case and in the three-dimensional case, the electrodes can be held on a support in order to stabilize their spatial structure. It is also possible for them to have been produced with the additional aid of the support, for example by deposition on a support in the form of a subsequently solidified liquid, by being wound onto a support or in another form. The term “wound form ” and in particular “the helical form ” moreover also encompasses “double-wound ” forms, for example as are known from incandescent lamp wires with a double coil. That is to say the electrode form should be wound there in the form of a helix along an axis which, for its part, again describes a helical form or correspondingly double-wound forms should be present. For illustrative purposes, reference is made to the third exemplary embodiment.

In addition, an auxiliary starting electrode can be used within the context of the invention in a particularly simple manner which can be applied easily, in particular in the case of a support for the electrodes which is easily accessible from the outside, and considerably improves the so-called dark-starting capability of a lamp.

Particularly favorable are tubular discharge vessels, in particular but not exclusively, those having a circular cross section. The meandering forms or wound forms of the electrodes can in this case be developed in a favorable manner along the axis of the tube.

Finally, in the context of dielectrically impeded discharges, those discharge lamps are preferred which operate without any mercury and are designed for producing noble gas excimers.

### BRIEF DESCRIPTION OF THE DRAWINGS

The invention will be explained in more detail below with reference to the exemplary embodiments, it being possible for the illustrated features also to be essential to the invention in other combinations.

FIG. 1 shows a schematic longitudinal section through a discharge lamp according to the invention as a first exemplary embodiment.

FIG. 2 shows, in a corresponding manner, a second exemplary embodiment.

FIG. 3 shows, in a corresponding manner, a third exemplary embodiment. FIGS. 4a and 4b show, in a corresponding manner, a fourth exemplary embodiment. FIGS. 5a and 5b show, in a corresponding manner, a fifth exemplary embodiment.

### BEST MODE FOR CARRYING OUT THE INVENTION

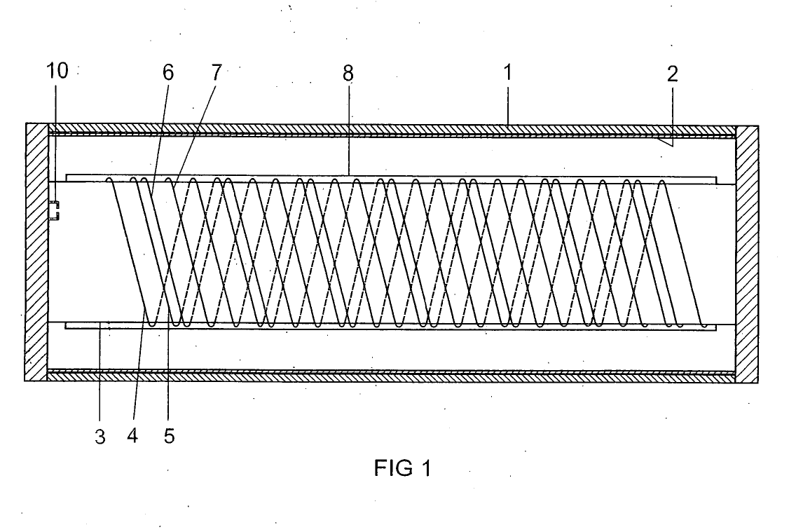

FIG. 1 shows a rod-shaped discharge lamp having a cylindrical discharge vessel 1, which has a circular cross section. The axis of the cylinder is horizontal in the plane of the paper in FIG. 1.

A reflective layer and a fluorescent layer are deposited in a manner known per se on the inner wall of the casing of the discharge vessel 1, and said layers are jointly denoted by 2.

In addition, a core tube 3 consisting of glass is fitted within the discharge vessel 1 as an electrode support in a manner which is not illustrated. Two pairs of electrodes 4 to 7 are wound in the form of a helical line around the core tube 3 and electrical contact is made with them in a manner which is likewise not illustrated. Mechanically holding glass tubes or glass bodies within a discharge vessel and making electrical contact with inner electrodes are known per se and are easy to implement for a person skilled in the art, with the result that they do not need to be illustrated in any more detail here.

In this case, a thin envelope bulb 8 is fitted to the electrode pairs 4, 5 and 6, 7 and to the core tube 3, said thin envelope bulb 8 only being illustrated symbolically in FIG. 1 and in fact being fused on. It is simply a thin-walled glass tube which can be pushed onto the electrodes and then fused on in the form of a dielectric layer in order to ensure a dielectric coating of all the electrodes 4 to 7. Instead, a glass solder can also be applied in liquid form and solidified, as is known per se for dielectric barrier discharge lamps.

The electrodes 4 to 7 are in this case wires wound onto the core tube 3. Instead, it is naturally also possible per se for techniques known from the dielectric barrier discharge lamp sector to be used, for example the application of liquid Ag pastes. Instead of the wire, a metal foil may also be wound on.

The electrode pairs 4, 5 and 6, 7 form a helical form which is concentric with respect to the discharge vessel 1 and can be formed by matching the pitch to the total length, which is practically independent of the length and also of the radius of the discharge vessel 1. In addition, the discharge gap, namely the gap between the electrodes 4 and 5 or 6 and 7 which remains essentially constant over the length of the electrode pairs, can be designed independently of the discharge vessel geometry and, in particular, independently of the wall thickness of the discharge vessel 1. Finally the thickness of the dielectric 8 may be considerably smaller than the wall thickness of the discharge vessel 1. The wall thickness of the discharge vessel 1 can therefore be optimized for reasons of stability and weight and does not need to be less, for electrical reasons, than is desired for other reasons. The helical form illustrated provides a good degree of homogeneity of the electrode distribution in the discharge vessel. In order to avoid undesirable discharges in the case of a small gap (as illustrated) between the electrode pairs, i.e. between the electrodes 5 and 6, and/or in the case of a low pitch, i.e. between the electrodes 4 and 7, the electrodes 4 and 7 and the electrodes 5 and 6 each have the same polarity. The gaps between the electrodes 4 and 7 or 5 and 6 can therefore be selected independently of the discharge gap. In particular, they could be equal. Adjacent pairs of electrodes having the same polarity could also be combined to form one electrode. However, it has already been shown in the past that, in the case of dielectrically impeded discharges, it is possible for individual discharge structures on opposite sides of one and the same anode to be influenced to a certain extent, and the anodes should therefore in any case advantageously have a dual design. During bipolar operation, this would then apply to all electrodes.

Moreover, the geometry can also be matched easily to desired luminance distributions by varying the pitch and/or the radius without deviating from the basic idea of the wound-on electrode form.

The reference 10 moreover refers to an auxiliary starting electrode known per se with which separate contact is made (not illustrated here). It is an active starting aid which is acted upon by the ballast when the lamp is started such that an ignition spark is produced.

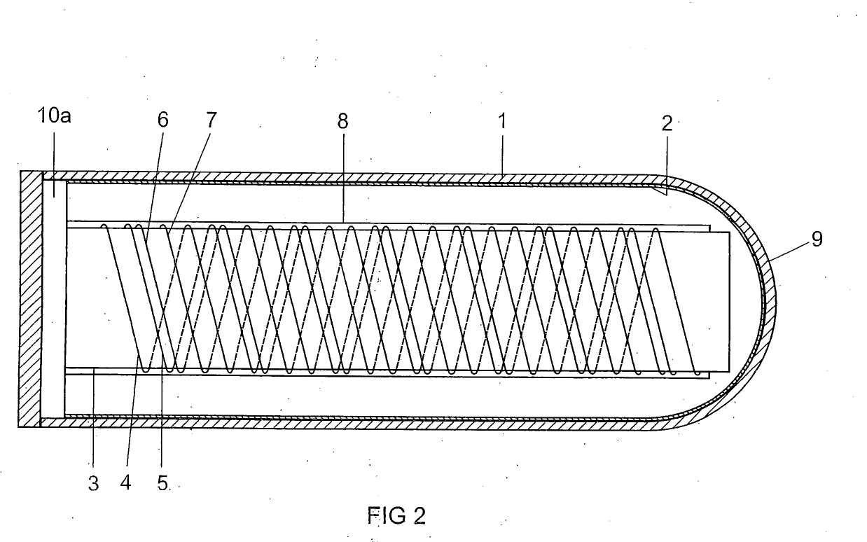

FIG. 2 shows one variant of FIG. 1 with a semi-spherical end 9 of the discharge vessel 1′ which is simpler in terms of glass production technology. However, in this case 10a indicates a passive starting aid, namely an auxiliary electrode, which in this range influences the electrical field such that the lamp starts better at this point. Moreover, this second exemplary embodiment corresponds to the first exemplary embodiment shown in FIG. 1 and is therefore not explained in any more detail. The references are therefore also omitted.

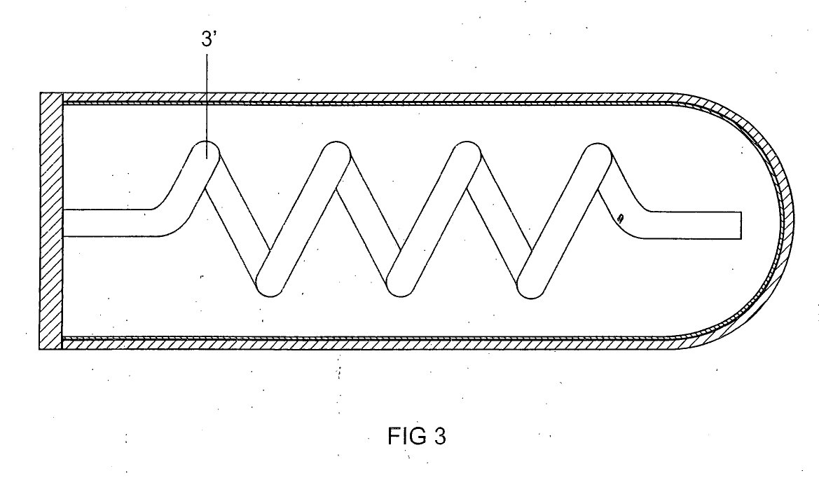

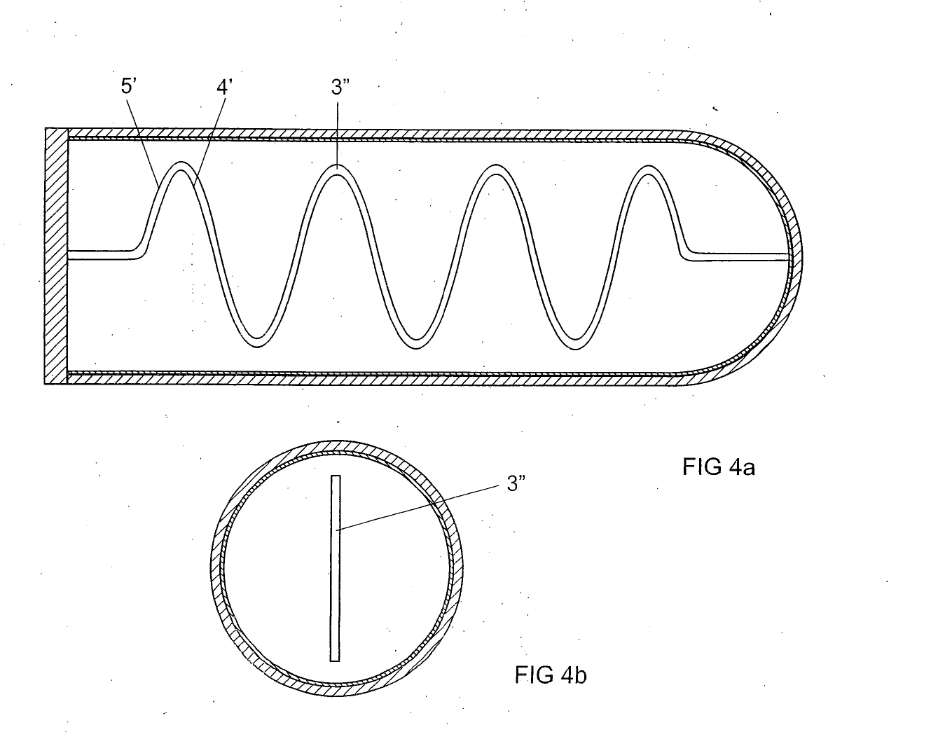

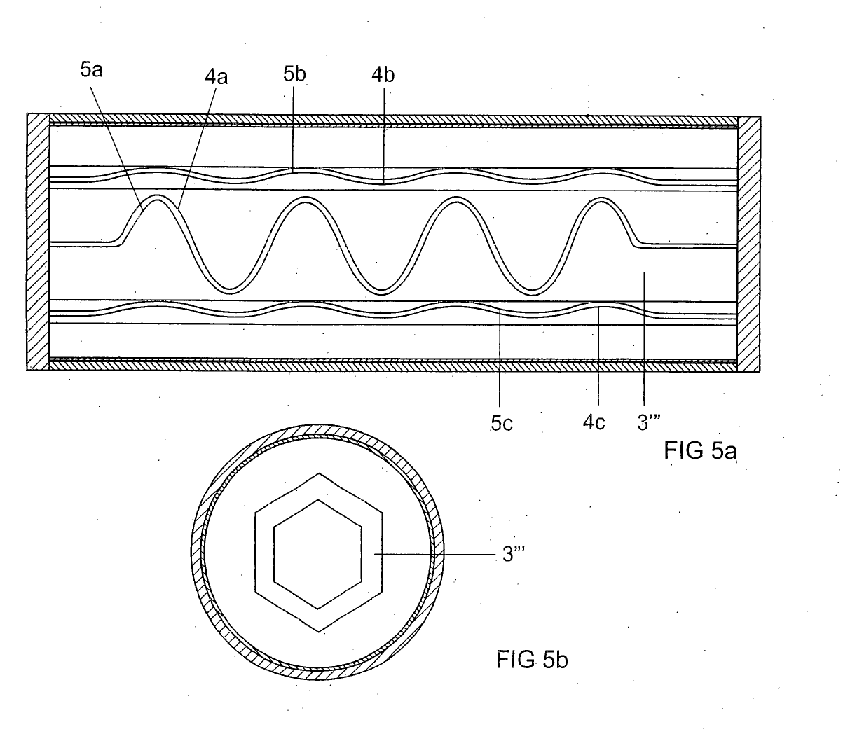

FIG. 3 shows a third exemplary embodiment. The difference between this embodiment and the second exemplary embodiment consists in the fact that the support 3′, i.e. the core tube, is in this case itself in the form of a helix. The electrodes (not illustrated here) are wound individually or else in multiples in pairs over the core tube 3′, i.e. to a certain extent in the form of a double helix. The resulting electrode form therefore corresponds to the form of so-called incandescent lamp wires with a double coil. This exemplary embodiment therefore provides two radii and two pitches for variation purposes and can achieve improved homogeneity in particular in the case of relatively large discharge lamps, in particular if the two radii, i.e. the radius of the cross section of the core tube 3′ and the radius of its helical form, differ to a less considerable extent than is illustrated in FIG. 3 for reasons of graphical clarity. FIGS. 4a and 4b finally show a longitudinal illustration and a cross-sectional illustration, respectively, of a fourth exemplary embodiment, in which a pair of electrodes 4′, 5′ run essentially sinuously and in the process two-dimensionally. In the left-hand illustration corresponding in terms of perspective to FIGS. 1-3, the electrodes therefore lie in the plane of the paper and are not wound spatially as in the first three exemplary embodiments. The right-hand detailed illustration accordingly shows a section, rotated through 90°, and, vertically and centrally, a support 3″for the electrodes 4′, 5′.

The last exemplary embodiment in FIGS. 5a and 5b largely corresponds to the explanations relating to FIGS. 4a , 4b , but this exemplary embodiment shows a support 3′″ which is polygonal, i.e. in this case hexagonal, in the section in the right-hand detailed illustration. In each case electrode pairs 4a , 5a and 4b , 5b and 4c , 5c are provided on the individual sides of the support 3′″, these electrode pairs corresponding to the electrode pair 4′, 5′ shown in FIGS. 4a , 4b . This can increase the light emission, and the light emission can be directed in various directions.

1. A discharge lamp having a discharge vessel and at least two electrodes in the discharge vessel, which are in the form of elongate paths and are formed as a pair of electrodes which are spaced essentially uniformly apart by the discharge gap, and of which at least one is dielectrically coated wherein the electrode pair has a path form having a plurality of path curves, the electrodes of the electrode pair being spaced essentially uniformly apart in the path curves.

2. The discharge lamp as claimed in claim 1, in which the curves of the path form of the electrode pair adjoin one another.

3. The discharge lamp as claimed in claim 2, in which the electrode paths essentially comprise the path curves in the discharge region.

4. The discharge lamp as claimed in claim 1, in which the electrode paths are unbranched.

5. The discharge lamp as claimed in claim 1, in which the path form of the electrode pair is two-dimensional and meandering.

6. The discharge lamp as claimed in claim 1, in which the path form of the electrode pair is curved three-dimensionally.

7. The discharge lamp as claimed in claim 6, in which the path form is wound, in particular in the form of a helix.

8. The discharge lamp as claimed in claim 7, in which the path form is in the form of a double helix.

9. The discharge lamp as claimed in claim 1, in which the electrodes are held on a support in the region of the path curves.

10. The discharge lamp as claimed in claim 1 having an auxiliary starting electrode in the discharge vessel.

11. The discharge lamp as claimed in claim 1, in which the discharge vessel is tubular, in particular with a circular cross section.

12. The discharge lamp as claimed in claim 1, which is designed for noble gas excimer discharges.

13. An illumination system having a discharge lamp as claimed in claim 1 and an electronic ballast designed for operating the discharge lamp.
